(19) United States
(12) Patent Application Publication
(10) Pub. No.: US 2024/0298620 A1
(43) Pub. Date: Sep. 12, 2024

(54) FISHING ASSEMBLY INCLUDING A NET HOUSING

(71) Applicant: Alexander Salvino, Western Springs, IL (US)

(72) Inventor: Alexander Salvino, Western Springs, IL (US)

(21) Appl. No.: 18/328,536

(22) Filed: Jun. 2, 2023

Related U.S. Application Data
(60) Provisional application No. 63/489,409, filed on Mar. 9, 2023.

(51) Int. Cl. A01K 87/00; A01K 77/00

(52) U.S. Cl. CPC A01K 87/007; A01K 77/005

(57) ABSTRACT

A fishing assembly includes a fishing pole and a housing coupled to the fishing pole. The housing defines a cavity sized to receive a collapsible net assembly therein. The fishing assembly further includes a net release mechanism for releasing the net assembly from the cavity. The net release mechanism is configured to engage the housing and is selectively releasable to disengage with the housing to allow the net assembly to be removed from the housing.

### CROSS-REFERENCE TO RELATED APPLICATION

This application claims priority to U.S. Provisional Patent Application No. 63/489,409, filed Mar. 9, 2023, the disclosure of which is hereby incorporated by reference herein in its entirety.

### BACKGROUND

The field of the disclosure relates generally to fishing assemblies, and more specifically, to fishing assemblies that include a housing for holding a fishing net therein.

Fishing poles include a rod and reel arrangement for selectively releasing a line having a baited and/or lured hook. When a fish is hooked, the line may be reeled in to bring the fish toward the fisherman. After the fish is reeled in, the fish may be captured out of the water by lifting the line and raising the fish out of the water environment. One difficulty presented by this technique is that added weight is applied to the connection between the hook at the end of the fishing line and the fish, which can loosen or even break the hooked connection with the fish and result in the loss of the catch. As a result, use of a net or some other device to capture the fish from the water may be desirable.

One problem with such known nets is that they are provided separately from the fishing poles. As a result, the nets are difficult to carry in combination with other fishing equipment when setting up at a suitable location. Moreover, some such nets may also be small and therefore present organizational challenges to readily stow and access the nets without them becoming lost or otherwise separated from the fishing pole. Thus, a need exists for providing a fishing assembly that provides the functionality of a fishing pole and a fishing net and which has an improved ease of access and portability.

### BRIEF DESCRIPTION

In one aspect, a fishing assembly is provided, the fishing assembly includes a fishing pole, a collapsible net assembly, and a housing coupled to the fishing pole. The housing defines a cavity sized to receive the collapsible net assembly therein. The fishing assembly further includes a net release mechanism for releasing the net assembly from the cavity, wherein the net release mechanism is configured to engage the housing and is selectively releasable to disengage with the housing to allow the net assembly to be removed from the housing.

In another aspect, a fishing assembly is provided. The fishing assembly includes a fishing pole and a housing coupled to the fishing pole. The housing defines a cavity sized to receive a collapsible net assembly therein. The fishing assembly further includes a net release mechanism for releasing the net assembly from the cavity. The net release mechanism is configured to engage the housing and is selectively releasable to disengage with the housing to allow the net assembly to be removed from the housing.

In yet another aspect, a housing configured to be coupled to a fishing pole is provided. The housing includes a body defining an internal cavity. The internal cavity being sized to receive a collapsible net assembly therein. The housing further includes a net release mechanism for releasing the net assembly from the cavity. The net release mechanism is configured to engage the net assembly and is selectively releasable to disengage with the net assembly to allow the net assembly to be removed from the housing.

### BRIEF DESCRIPTION OF THE DRAWINGS

FIG. 1 is a schematic perspective view of an example fishing assembly in a closed configuration.

FIG. 2 is a schematic perspective view of the fishing assembly shown in FIG. 1, showing the fishing assembly in an opened configuration.

FIG. 3 is a schematic top view of a net assembly for use with the fishing assembly shown in FIG. 1, showing the net assembly in an expanded configuration.

FIG. 4 is a schematic top view of the net assembly shown in FIG. 3, showing the net assembly in a collapsed configuration.

FIG. 5 is a schematic perspective view of an alternative embodiment of a fishing assembly.

FIG. 6 is a schematic cross section view of a portion of the fishing assembly shown in FIG. 5.

### DETAILED DESCRIPTION

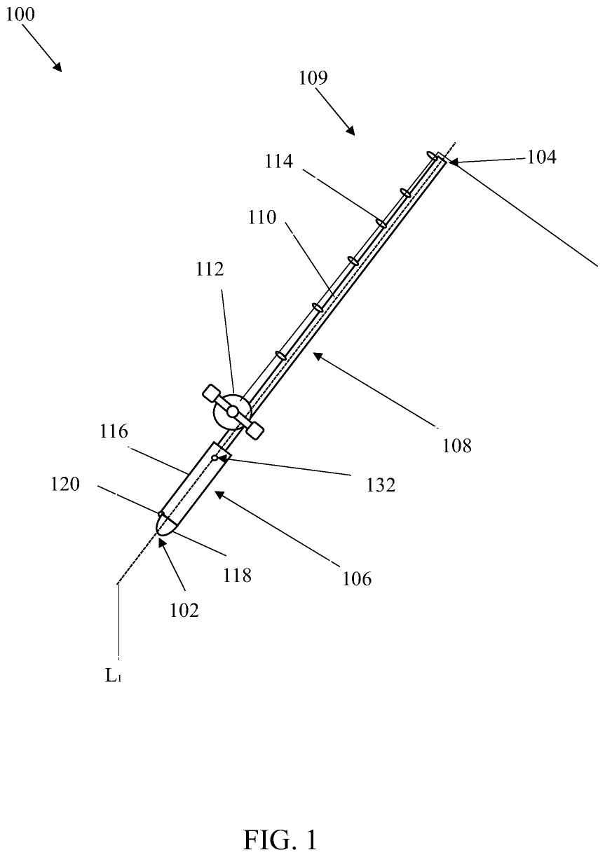

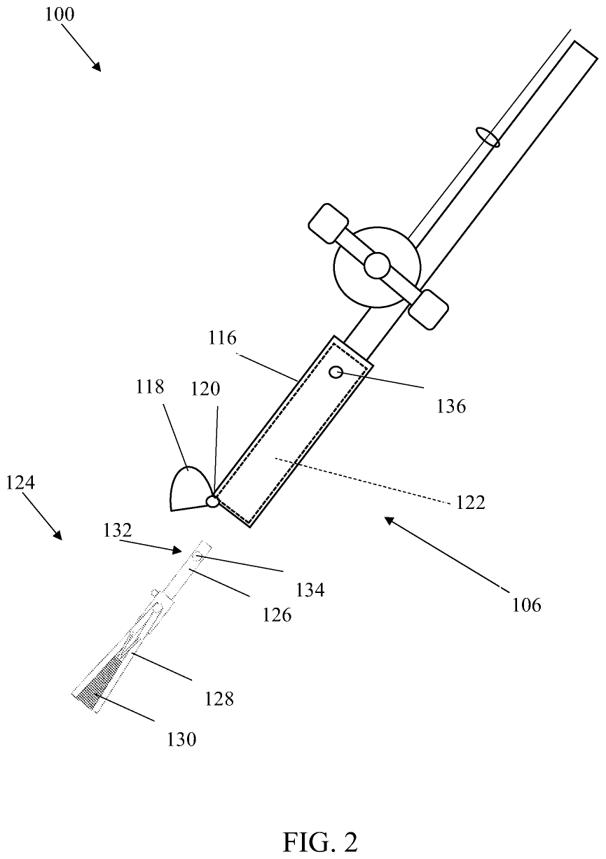

FIG. 1 is a perspective view of an example fishing assembly 100 in a closed configuration. FIG. 2 is a perspective view of the example fishing assembly 100 in an opened configuration.

Referring to FIG. 1, in the example embodiment, the fishing assembly 100 is a fishing pole 109 that extends between a base end 102 and a distal end 104. The fishing assembly 100 defines a longitudinal axis L₁ that extends through the base end 102 and the distal end 104. The fishing assembly 100 further includes a handle section 106 defining the base end 102 and a pole section 108 extending from the handle section 106 to the distal end 104. The pole section 108 includes a pole blank 110, a reel 112 coupled to the pole blank 110, and a plurality of guide rings 114 connected to the pole blank 110. In the example embodiment, the fishing assembly 100 is a casting fishing rod. In other embodiments, the fishing assembly 100 may be any other suitable type of fishing rod such as, for example and without limitation, a spin fishing rod, a telescoping fishing rod, a fly-fishing rod, an “ultra-light” fishing rod, a surf fishing rod, a trolling rod, and an ice fishing rod.

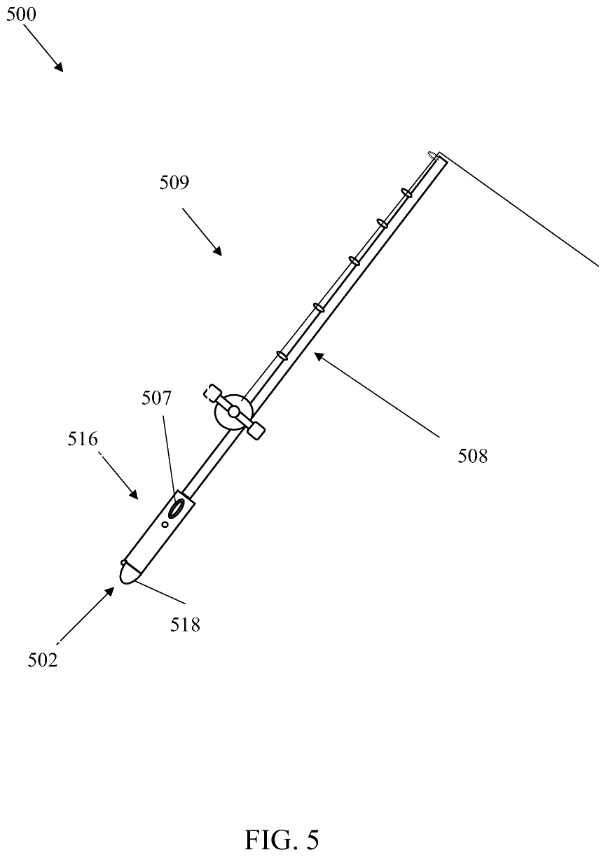

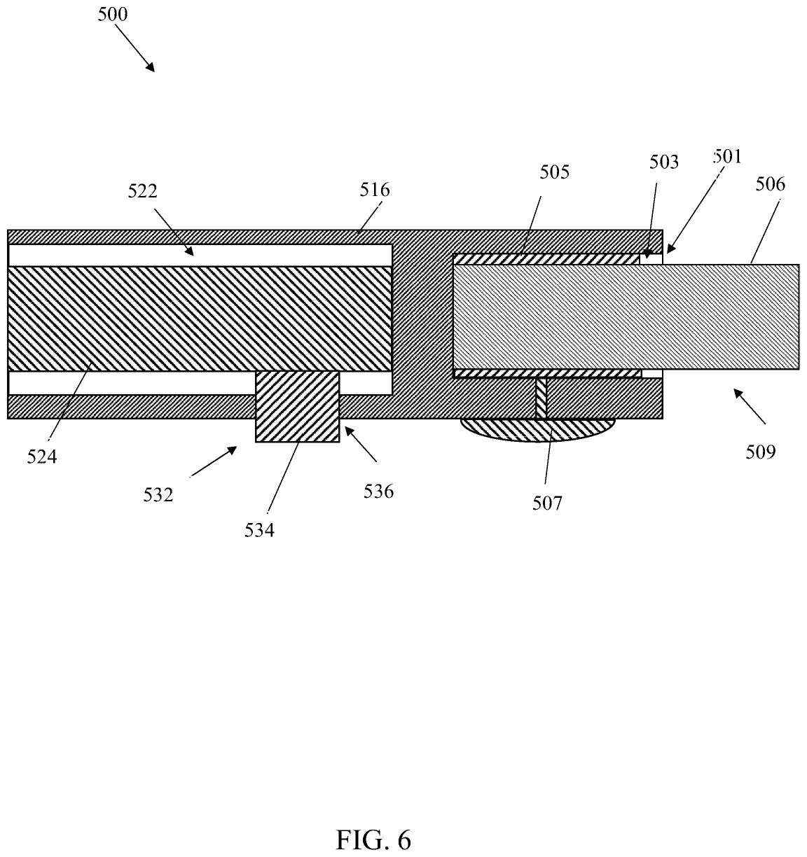

In the example embodiment, the handle section 106 includes a housing 116, a cap 118, and a hinge 120. The housing 116 is coupled to the pole section 108, or, more specifically, is integrally assembled with the pole section 108 such that the housing 116 forms the handle section 106 of the fishing pole 109. In other embodiments, such as in the embodiment described with respect to FIGS. 5 and 6, the housing 116 may be removably coupled to the pole section 108 and may be configured to be used with existing fishing poles.

In the example embodiment, the cap 118 is movably coupled to the housing 116 via the hinge 120. More specifically, in the example embodiment, the cap 118 is pivotable relative to the housing 116 about the hinge 120 from a closed position, as shown in FIG. 1 to an open position, as shown in FIG. 2.

Referring to FIG. 2, when in the open position, the cap 118 is rotated about the hinge 120 to provide access to an internal cavity 122 defined within the housing 116. Opening the cap 118 provides access to and facilitates the release of a net assembly 124 positioned within the housing 116. In other embodiments, the cap 118 is movably coupled to the housing 116 in any suitable manner that enables the fishing assembly 100 to function as described herein. For example, in some embodiments, the cap 118 threadably attaches to the housing 116 and is twisted in a first direction to remove the cap 118 from the housing 116 and may be twisted in an opposed second direction to tighten the cap 118 on the housing 116. In other embodiments, the cap 118 and/or housing 116 includes a latching mechanism (not shown) for securing the cap 118 in the closed position. For example, in some such embodiments, the cap 118 includes a retractable projection (not shown) that engages a portion of the housing 116 and which may be retracted to unlock the cap 118 on the handle to enable rotating the cap 118 about the hinge 120 to the closed position, as shown in FIG. 2.

Referring to FIG. 2, in the example embodiment, the net assembly 124 includes a net handle 126, a net frame 128 coupled to the net handle 126, and a netting 130 coupled to and extending across the net frame 128. The fishing assembly 100 further includes a net release mechanism 132 for securing the net assembly 124 within the housing 116 and facilitating release of the net assembly 124 when the cap 118 is opened. In the example embodiment, the net release mechanism 132 includes an extendable button 134 coupled to the net handle 126 and an aperture 136 defined within the housing 116. More specifically, in the example embodiment, the net release mechanism 132 is a snap-button ferrule mechanism. In the example embodiment, the net assembly 124 has a longitudinal length that is less than a longitudinal length of the internal cavity 122 defined within the housing 116.

In the example embodiment, the button 134 is biased outwards (i.e., out of the page in FIG. 2) of the net handle 126 and is retractable inwards (i.e., into the page in FIG. 2) when sufficient force or pressure is applied to the button 134. When the net assembly 124 is received within the internal cavity 122, the button 134 is positioned in alignment with the aperture 136 defined in the housing 116 and extends through the aperture 136 to lock the net assembly 124 in position within the internal cavity 122. To remove the net assembly 124, the cap 118 is opened and the button 134 is depressed into the aperture 136 and into contact with an interior surface of the housing 116, thereby allowing the net assembly 124 to slide outwards along the longitudinal axis L₁ and out of the handle section 106. In the example embodiment, the net assembly 124 is loaded into the handle section 106 by depressing the button 134, sliding the net assembly 124 into the handle section 106, with a handle end of the net being inserted first, and positioning the net assembly 124 within the handle section 106 such that the button 134 is positioned in alignment with the aperture 136 and is biased outwards at least partially into the aperture 136. In other embodiments, the net assembly 124 may be loaded into the handle section 106 by inserting the net frame end first. In some such embodiments, the aperture 136 may be defined in the handle section 106 proximate the base end 102 of the fishing assembly 100, such that the button 134 on the net handle 126 is aligned with the aperture 136 when the net assembly 124 is loaded into the internal cavity 122 with the net frame 128 end first.

In other embodiments, the button 134 may engage one or more other structures of the handle section 106 to lock the net assembly 124 in position within the housing 116. For example, and without limitation, in some embodiments, the housing 116 additionally or alternatively includes one or more internal recesses (not shown) defined on an interior surface within the housing 116 and the button 134 extends into and engages the one or more internal recesses to lock the net assembly 124 in position within the housing 116. Additionally or alternatively, in some embodiments, the net assembly 124 includes a plurality of buttons which may each engage one or more corresponding structures of the housing 116. Moreover, in other further embodiments, the fishing assembly 100 may include any suitable release mechanism that enables the net assembly 124 to selectively engage the handle section 106 as described herein. For example, in some embodiments, the housing 116 includes one or more latches (not shown) that selectively engage the net assembly 124 within housing 116. Additionally or alternatively, the fishing assembly 100 may further include a biasing mechanism (not shown) for biasing the net assembly 124 out of the handle section 106 when the release mechanism is actuated. In one example, the biasing mechanism includes a spring positioned within the handle section 106 that is compressed when the net assembly 124 is loaded into the handle section 106 and which is biased to expand when the net assembly 124 is released to drive the net assembly 124 out of the handle section 106.

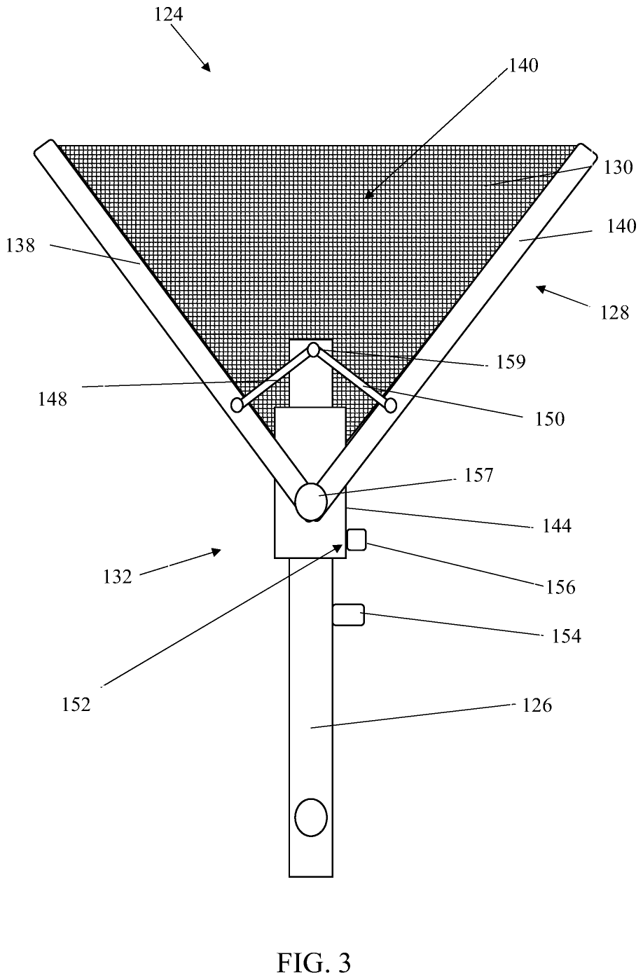

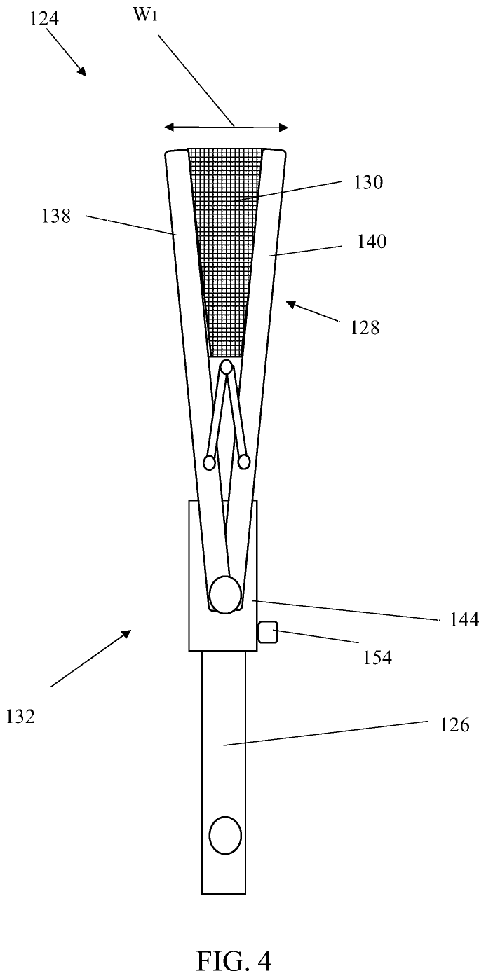

FIG. 3 is a top view of the net assembly 124 in an expanded configuration. FIG. 4 is a top view of the net assembly 124 in a collapsed configuration.

Referring to FIG. 3, in the example embodiment, netting 130 is attached to the net frame 128 and extends across the net frame 128. The netting 130 is further slacked between the net frame 128 to provide a net pouch (not shown) for carrying one or more fish therein during use. In the example embodiment, the netting 130 is formed of a rubber material. In other embodiments, the netting 130 may be formed of any suitable materials.

In the example embodiment, the net frame 128 includes a first frame link 138 and a second frame link 140. The net frame 128 is formed of a metal material, though in other embodiments, the net frame 128 may be formed of any suitable materials.

In the example embodiment, the net assembly 124 includes a net release mechanism 132 for transitioning the net assembly 124 between the expanded configuration shown in FIG. 3 and the collapsed configuration shown in FIG. 4.

In the expanded configuration, shown in FIG. 3, the net frame 128 is expanded to define a pocket 140 therein for holding a fish. Referring to FIG. 4, in the collapsed configuration, the net frame 128 is collapsed inward of the net assembly 124 for loading the net assembly 124 into the internal cavity 122 of the housing 116 (shown in FIG. 2). More specifically, in the collapsed configuration, the net assembly 124 has an overall width W₁ that is approximately equal to or less than a diameter of the internal cavity 122 (shown in FIG. 2). As a result, when in the collapsed configuration, the net assembly 124 is sized to fit within the internal cavity 122 defined in the housing 116. In some embodiments, the net assembly 124 may have an increased longitudinal length when in the expanded configuration relative to the collapsed configuration. For example, in some such embodiments, the handle includes a plurality of telescopingly extendable handle sections (not shown) that are extended when the net assembly 124 is in the expanded configuration and which are retracted when the net assembly 124 is in the collapsed configuration.

Referring back to FIG. 3, in the example embodiment, the net release mechanism 132 includes a runner 144, the first frame link 138, the second frame link 140, a first inner link 148, and a second inner link 150. The runner 144 is slidably coupled to the net handle 126 and is operable to be slid along the handle 126 to transition the net assembly 124 between the collapsed configuration and the expanded configuration. The net release mechanism 132 further includes a runner locking assembly 152 which secures the runner 144 in position on the handle in both the collapsed configuration and the expanded configuration.

In the example embodiment, the runner locking assembly 152 is a snap-button ferrule mechanism that includes one or more buttons 154 configured to engage the net handle 126 and the runner 144. To transition the net assembly 124 from the collapsed configuration to the expanded configuration, a user may depress the button 154 of the runner lock 146, allowing the runner 144 to slide from a lowered position on the net handle 126 to a raised position on the net handle 126. The user may then lock the net assembly 124 in the expanded configuration by aligning the runner 144 with one or more buttons 156 on the net handle 126 when the runner 144 is in the raised position. More specifically, in the example embodiment, the runner locking assembly 152 includes a first spring loaded button 154 and a second spring loaded button 156 each coupled to the handle assembly. The runner 144 further defines one or more apertures (not shown) that are positioned to align with the first and second button 154, 156. For example, referring to FIG. 4, in the collapsed configuration, the first button 154 extends through the aperture defined in the runner 144 to lock the runner 144 in the collapsed configuration. To transition the net assembly 124 to the expanded configuration, the first button 154 is depressed and the runner 144 is slid along the handle 126 to the raised position, as shown in FIG. 3. The second button 156 is biased outwards through the corresponding aperture in the runner 144 when the runner 144 is in the raised position to lock the net assembly 124 in the expanded configuration.

In other embodiments, any suitable release mechanism may be used to transition the net assembly 124 between the collapsed configuration and the expanded configuration. For example, and without limitation, in some embodiments, one or more of the buttons 154, 156 may be provided on the runner 144 and may engage an outer structure that extends around the runner 144. In further embodiments, the runner 144 may include a clamping mechanism (not shown) that provides a friction fit between the runner 144 and the handle to secure the runner 144 in position on the handle 126 and lock the net assembly 124.

Referring back to FIG. 3, in the example embodiment, the first frame link 138 and the second frame link 140 are each pivotally connected to the runner 144. The first inner link 148 is pivotally connected to the net handle 126 and to the first frame link 138. The second inner link 150 is pivotally connected to the net handle 126 and the second frame link 140. In the example embodiment, the first frame link 138 and the second frame link 140 are each connected to the runner 144 at a common first pivot point 157 and the first inner link 148 and second inner link 150 are likewise each connected to the net handle 126 at a common second pivot point 159. In other embodiments, any one of the first frame link 138, second frame link 140, first inner link 148, and second inner link 150 may be connected at separate and/or otherwise pivot points on the handle and the runner 144, respectively. The pivotal connections between the first frame link 138, the first inner link 148, the runner 144, the handle, the second inner link 150, and the second frame link 140 cause the first frame link 138 and the second frame link 140 to fan outwards from the handle as the runner 144 is moved from the lowered position (shown in FIG. 4) to the raised position (shown in FIG. 3).

FIG. 5 is a perspective view of an alternative fishing assembly 500. FIG. 6 is a cross section view of a portion of the fishing assembly 100 of FIG. 5. The fishing assembly 500 of FIGS. 5 and 6 is substantially the same as the fishing assembly 100 of FIGS. 1-4, except as otherwise described differently herein. In particular, in the example embodiment, the fishing assembly 500 includes a housing 516 that holds a net assembly 524 (shown in FIG. 6) therein in substantially the same manner as described with respect to FIGS. 1-4 except that, in the example embodiment, the housing 516 is removably coupled to the pole section 508 of the fishing pole 509. As a result, and as explained in greater detail below, the housing 516 may be retrofitted onto existing fishing poles and/or may otherwise be removed from the fishing pole 509.

Referring to FIG. 6, in the example embodiment, the housing 516 includes an open end 501 opposite the cap 518 (shown in FIG. 5) and defines a pole cavity 503 extending longitudinally inward of the housing 516 from the open end 501. In the example embodiment, the pole cavity 503 is generally tube or cylindrical shaped, in correspondence with the shape of the fishing pole 509 and is sized to receive the fishing pole 509 therein.

In the example embodiment, the housing 516 further defines an internal cavity 522 that receives the net assembly 524 therein in substantially the same manner as described with respect to FIGS. 1-4. In particular, in the example embodiment, the fishing assembly 500 further includes a net release mechanism 532 including a button 534 that extends from the net assembly 524 and through the aperture 536 defined in the housing 516.

The housing 516 further includes a clamp 505 which engages the fishing pole 509, and specifically the handle section 506 of the pole, to secure the housing 516 to the fishing pole 509. In particular, in the example embodiment, the clamp 505 extends inwards of the housing 516 in the pole cavity 503 and provides a friction fit between the housing 516 and the fishing pole 509. The clamp 505 is adjustable by a crank 507 or, more broadly, an “adjustment mechanism”, that is accessible from an exterior of the housing 516. In particular, rotation of the crank 507 in a first direction moves the clamp 505 radially inward to provide engagement between the clamp 505 and the fishing pole 509. Rotation of the crank 507 in a second, opposite, direction, moves the clamp 505 radially outward to allow for removal of the fishing pole 509 from the housing 516.

In other embodiments, any suitable clamp 505 or, more broadly, connection device, may be used to removably attach the housing 516 to fishing pole 509. For example, and without limitation, in some embodiments the clamp 505 may include one or more prongs (not shown) that extended into the fishing pole 509 to secure the fishing pole 509 in position within the pole cavity 503. Moreover, in other embodiments, the housing 516 may attach to a different surface or portion of the fishing pole 509. For example, in some embodiments the housing 516 does not receive the entire diameter of the fishing pole 509 therein but may instead attach to a portion of the handle section 506 upwards on the fishing pole 509 from the base end 502.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fishing assembly comprising:
a fishing pole:
a collapsible net assembly
a housing coupled to the fishing pole, the housing defining a cavity sized to receive the collapsible net assembly therein; and
a net release mechanism for releasing the net assembly from the cavity, wherein the net release mechanism is configured to engage the housing and is selectively releasable to disengage with the housing to allow the net assembly to be removed from the housing.

2. The fishing assembly of claim 1, wherein the net assembly includes a handle, a collapsible frame coupled to the handle, and a netting coupled to the collapsible frame.

3. The fishing assembly of claim 2, wherein the housing defines an aperture and the release mechanism includes a button coupled to the handle and biased outwardly therefrom, wherein the button is aligned with the aperture in the housing when the net assembly is received within the cavity to lock the net assembly in position within the cavity.

4. The fishing assembly of claim 2, wherein the housing defines an internal recess and the release mechanism includes a button coupled to the handle and biased outwardly therefrom, wherein the button is aligned with the internal recess in the housing when the net assembly is received within the cavity to lock the net assembly in position within the cavity.

5. The fishing assembly of claim 1, wherein the housing includes a body, a cap, and a hinge coupling the cap to the body, the cap being configured to open on the body by rotation about the hinge to provide access to the net assembly in the cavity.

6. The fishing assembly of claim 1, wherein the net assembly includes a handle, a netting coupled to the handle, a frame, and a net release mechanism pivotally connecting the frame to the handle, the net release mechanism configured to transition the net assembly between a collapsed configuration, in which the net assembly is sized to be received within the cavity, and an expanded configuration.

7. The fishing assembly of claim 6, wherein the net release mechanism includes a runner slidably coupled to the handle, a first frame link of the net frame and a second frame link of the net frame, the first frame link and the second frame link each being pivotally coupled to the runner.

8. The fishing assembly of claim 7, wherein the net release mechanism further includes a locking assembly for locking the net assembly in the expanded or collapsed positions, the locking assembly including a snap button ferrule mechanism.

9. The fishing assembly of claim 7, wherein the first frame link and the second frame link are each attached to the netting.

10. The fishing assembly of claim 7, wherein the net release mechanism further includes a first inner frame link and a second inner frame link, the first inner frame link being pivotally coupled to the net handle and to the first frame link, the second inner frame link being pivotally coupled to the net handle and the second frame link.

11. The fishing assembly of claim 10, wherein the first frame link and the second frame link are pivotally coupled to the runner at a first pivot point, and wherein the first inner frame link and the second inner frame link are pivotally coupled to the runner at a second pivot point.

12. The fishing assembly of claim 1, wherein the housing is integrally formed with the fishing pole.

13. The fishing assembly of claim 1, wherein the housing is removably coupled to the fishing pole.

14. The fishing assembly of claim 13, wherein the housing defines a pole cavity sized to receive at least a portion of the fishing pole therein and an adjustable clamp positioned within pole cavity for securing the housing to the fishing pole.

15. A fishing assembly comprising:
a fishing pole:
a housing coupled to the fishing pole, the housing defining a cavity sized to receive a collapsible net assembly therein; and
a net release mechanism for releasing the net assembly from the cavity, wherein the net release mechanism is configured to engage the housing and is selectively releasable to disengage with the housing to allow the net assembly to be removed from the housing.

16. The fishing assembly of claim 15, wherein the net assembly includes a handle, a collapsible frame coupled to the handle, and a netting coupled to the collapsible frame, the net release mechanism including an aperture defined by the housing sized and positioned to align with a button coupled to the handle when the net assembly is received within the cavity to lock the net assembly in position within the cavity.

17. The fishing assembly of claim 15, wherein the housing includes a body, a cap, and a hinge coupling the cap to the body, the cap being configured to open on the body by rotation about the hinge to provide access to the net assembly in the cavity.

18. The fishing assembly of claim 15, wherein the housing is removably coupled to the fishing pole.

19. A housing configured to be coupled to a fishing pole, the housing comprising:
a body defining an internal cavity, the internal cavity being sized to receive a collapsible net assembly therein; and
a net release mechanism for releasing the net assembly from the cavity, wherein the net release mechanism is configured to engage the net assembly and is selectively releasable to disengage with the net assembly to allow the net assembly to be removed from the housing.

20. The housing of claim 19 further comprising a cap and a hinge coupling the cap to the body, the cap being configured to open on the body by rotation about the hinge to provide access to the net assembly in the internal cavity.
